(19) United States
(12) Patent Application Publication
(10) Pub. No.: US 2002/0092939 A1
(43) Pub. Date: Jul. 18, 2002

(54) Hypodermic needle and syringe decontaminating and destroying apparatus

(76) Inventors: David A. Sowers, (US); Sandra Sowers, Coral Springs, FL (US)

Correspondence Address: FRANK L. KUBLER, 13261 S.W. 54th Court, Miramar, FL, 33027, US

(21) Appl. No.: 10/003,874

(22) Filed: Oct. 24, 2001

Related U.S. Application Data
(63) Continuation-in-part of application No. 09/764,570, filed on Jan. 18, 2001.

(51) Int. Cl. B02C 19/12

(52) U.S. Cl. 241/65; 241/606

(57) ABSTRACT

An apparatus for decontaminating and destroying hypodermic syringes and needles includes a waste compression cylinder having a cylinder side wall and a closed cylinder abutment end wall, and having a cylinder waste receiving port in the cylinder side wall and a waste releasing port in the cylinder side wall; a waste compression piston slidably retained within the waste compression cylinder; a piston drive mechanism drivably connected to the waste compression piston for driving the piston away from the abutment end wall to open space for receiving waste within the compression cylinder and for driving the piston toward and into close proximity with the cylinder abutment end wall to crush needles; a decontaminating air blowing mechanism oriented to blow decontaminating air into the compression cylinder; and an air heating mechanism for heating the decontaminating air to a decontaminating temperature.

### FILLING HISTORY

This application is a continuation-in-part of application ser. No. 09/764,570 filed on Jan. 18, 2001.

### BACKGROUND OF THE INVENTION

1. Field of the Invention

The present invention relates generally to the field of hazardous waste disposal. More specifically the present invention relates to an apparatus which disposes of infectious and sharps waste by decontaminating, melting and compressing hypodermic syringes and decontaminating, crushing and encasing needles in melted syringe material. The apparatus includes a waste compression cylinder having a cylinder side wall and a closed cylinder abutment end wall and containing a waste compression piston drivably connected to piston drive means, a cylinder waste receiving port in the side wall, and having a waste releasing port in its side wall. A cylinder waste receiving door corresponding to the cylinder waste receiving port, and waste receiving door displacement means which automatically opens and closes the waste receiving door to pass waste into the cylinder, are optionally provided in a second embodiment. The piston drive means slides the piston away from the abutment end wall to open space for receiving waste and slides the piston toward and into close proximity with the cylinder abutment end wall to crush needles. A air heating means is provided for heating the decontaminating air to a decontaminating temperature and a decontaminating air blowing means is also provided and oriented to blow the heated air into the cylinder through an entry port. An exit port is optionally provided, although it is preferred that the air simply leak out of cylinder openings.

2. Description of the Prior Art

There have long been hypodermic syringes and needles requiring safe disposal after use. Various devices have been developed for destroying and decontaminating such medical waste. One example is an apparatus known as the STERITECH™ Medical Waste Treatment System for management of infectious and sharps waste. This system employs permeable heavy-duty bags known as red bags for receiving containers of infectious waste, and the waste is treated by exposure to steam to decontaminate the waste. After steam exposure, the waste is subjected to sufficient heat to melt the plastic syringes. A problem with the STERITECH™ apparatus is that it is a large, bulky free standing machine which is very costly to manufacture and to purchase.

It is thus an object of the present invention to provide an apparatus which decontaminates and destroys plastic hypodermic syringes and needles by heating the syringes and needles until they are decontaminated and further heating them until the syringes begin to melt, and by subsequently crushing the syringes and needles so that the needles bend and the melted syringe material encases the bent needles.

It is another object of the present invention to provide such an apparatus which is highly compact and light weight, such that the apparatus can be carried by hand easily by a single person and kept on top of an ordinary table.

It is still another object of the present invention to provide such an apparatus which is safe and easy to operate.

It is finally an object of the present invention to provide such an apparatus which is relatively inexpensive to manufacture and is highly reliable.

### SUMMARY OF THE INVENTION

The present invention accomplishes the above-stated objectives, as well as others, as may be determined by a fair reading and interpretation of the entire specification.

An apparatus is provided for decontaminating and destroying hypodermic syringes and needles, including a waste compression cylinder having a cylinder side wall and a closed cylinder abutment end wall, and having a cylinder waste receiving port in the cylinder side wall and a waste releasing port in the cylinder side wall; a waste compression piston slidably retained within the waste compression cylinder; a piston drive mechanism drivably connected to the waste compression piston for driving the piston away from the abutment end wall to open space for receiving waste within the compression cylinder and for driving the piston toward and into close proximity with the cylinder abutment end wall to crush needles; a decontaminating air blowing mechanism oriented to blow decontaminating air into the compression cylinder; and an air heating mechanism for heating the decontaminating air to a decontaminating temperature.

The apparatus preferably additionally includes a waste receiving door movably covering the waste receiving port. The apparatus preferably still additionally includes a waste receiving door displacement mechanism for automatically opening and closing the waste receiving door to pass waste into the cylinder. The apparatus preferably further includes a timer for setting a duration for operation of the air blowing mechanism sufficient to cause decontamination of needles and syringes contained within the compression cylinder. The apparatus preferably still further includes a waste collection vessel positioned below the cylinder waste releasing port.

The apparatus preferably includes an apparatus housing having a housing wall and containing the compression cylinder and including compression cylinder mounting structures holding the compression cylinder in a substantially horizontal position. The apparatus further preferably includes a housing waste receiving opening in the housing wall located above and registering with the cylinder waste receiving port. The housing preferably includes a housing waste receiving door and a housing waste receiving door displacement mechanism. The housing preferably contains a waste collection vessel removably retained within the housing below the cylinder waste releasing port. The apparatus preferably additionally includes a vessel removal port and vessel removal door removably covering the vessel removal port for providing access to the collection vessel for periodic removal and emptying of the collection vessel. The vessel removal door preferably includes a door locking mechanism having means for locking the vessel door closed over the vessel port.

The apparatus preferably further includes an apparatus circuit having operation duration and sequencing elements controlling operation of the cylinder waste receiving door and the piston drive mechanism. The preferably still further includes an apparatus circuit board electrically connected to the apparatus circuit and having apparatus controls.

The waste collection vessel preferably includes a tubular vessel side wall having an upper side wall region with external vessel threads and having a vessel side wall lower end; a vessel bottom wall sealingly secured across and closing the tubular vessel side wall lower end; a vessel lid with internal lid threads sized and pitches to screw onto the external vessel threads. The external vessel threads and the lid threads optionally are of a mutually locking configuration so that once the vessel lid is screwed onto the vessel side wall upper end region, the vessel lid does not screw off the vessel side wall upper end region. The external vessel threads and the lid threads comprise one-way grooves. The apparatus preferably additionally includes an apparatus circuit having operation duration and sequencing elements controlling operation of the cylinder waste receiving door and the piston drive mechanism. The apparatus preferably additionally includes an apparatus controls circuit board electrically connected to the apparatus circuit and having apparatus controls.

The piston drive mechanism preferably includes a longitudinal slot in the cylinder; a piston drive motor; an external drive rod drivably connected to the piston drive motor; and lateral drive arm having an external end and extending out of the cylinder through the longitudinal slot the external end of the drive arm includes accommodations to affix two threaded drive nuts which engage the drive rod.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a perspective view of a secondarily preferred, earlier embodiment of the apparatus.

FIG. 2 is a cross-sectional top view of the compression cylinder, piston and piston drive means, air blowing means and air heating means of the apparatus of FIG. 1.

FIG. 3 is a perspective view of the compression cylinder, piston and piston drive means, air blowing means and air heating means of FIG. 1.

FIG. 4 is a perspective top view of the apparatus of FIG. 1 with top panel of the housing wall removed to reveal the internal structure.

FIG. 5 is a perspective view of the current, preferred apparatus housing frame, circuit and circuit board.

FIG. 6 is a perspective view of the apparatus of FIG. 5 with the vessel removal door removed and the control panel removed from the housing to reveal the control panel port.

FIG. 7 is a broken away perspective rear view of the apparatus housing of FIG. 5 with the rear housing wall removed, showing the interior of the housing, the hinges and locking mechanism of the vessel removal door, and showing the power outlet.

FIGS. 8-11 are perspective views of the apparatus of FIG. 5 with the housing removed, and with the control panel in the foreground.

FIG. 12 is a perspective, exploded view of the waste collection vessel and vessel lid, showing the locking threads for securing the lid onto the vessel.

FIG. 13 is a schematic representation of the elements of the upper circuit board.

FIGS. 14-17 are schematic representations of the elements of the lower circuit board.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### First Preferred Embodiment

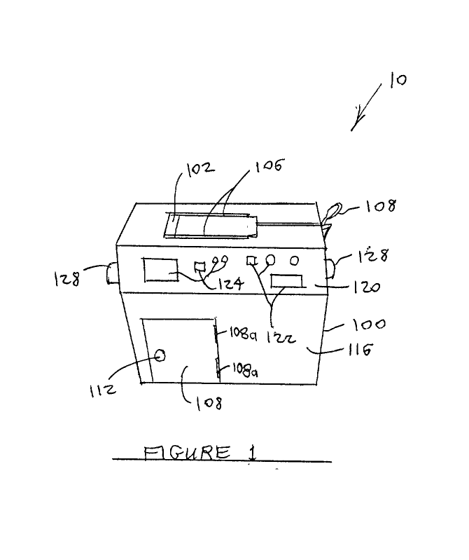

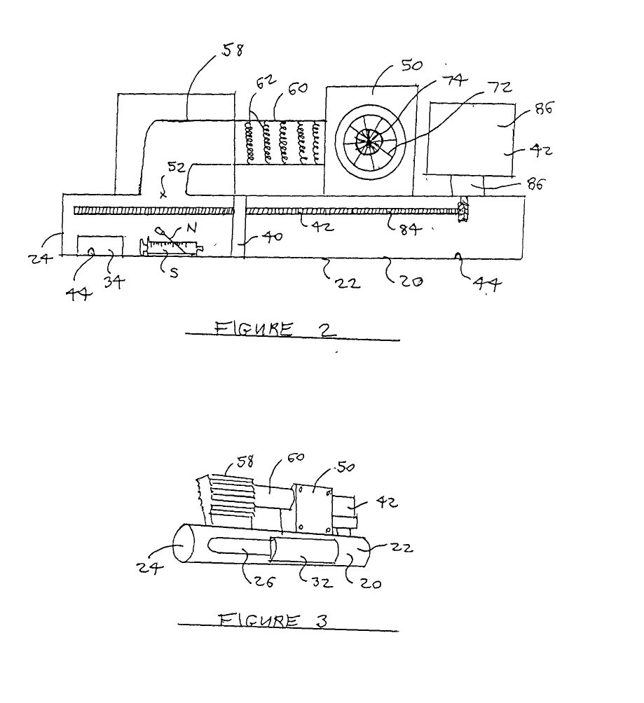

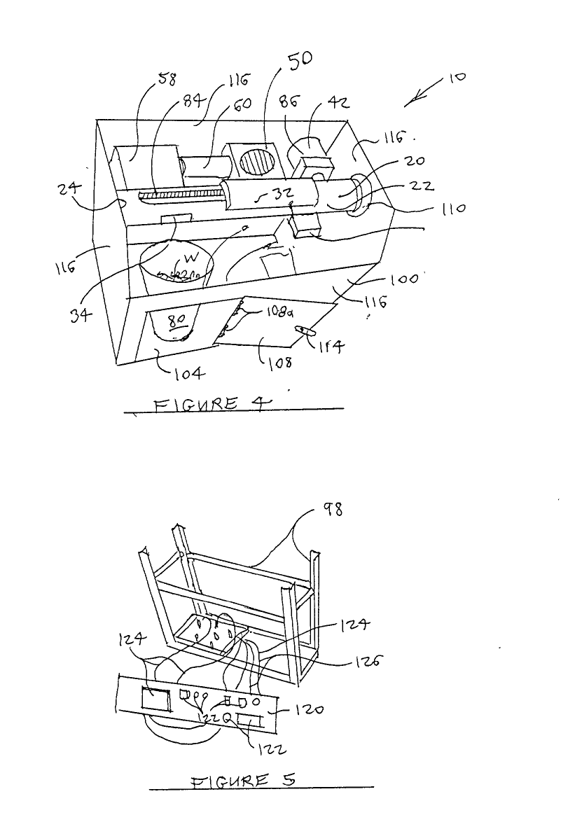

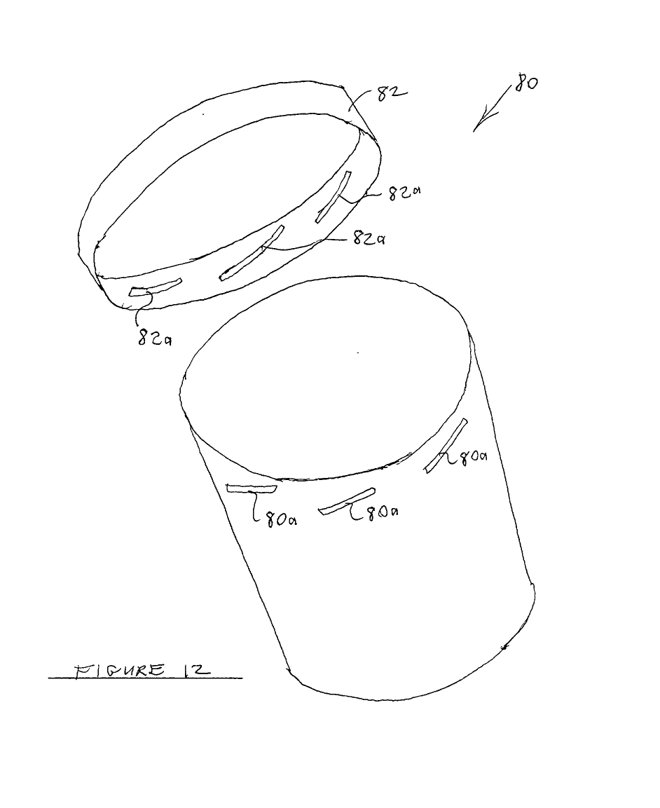

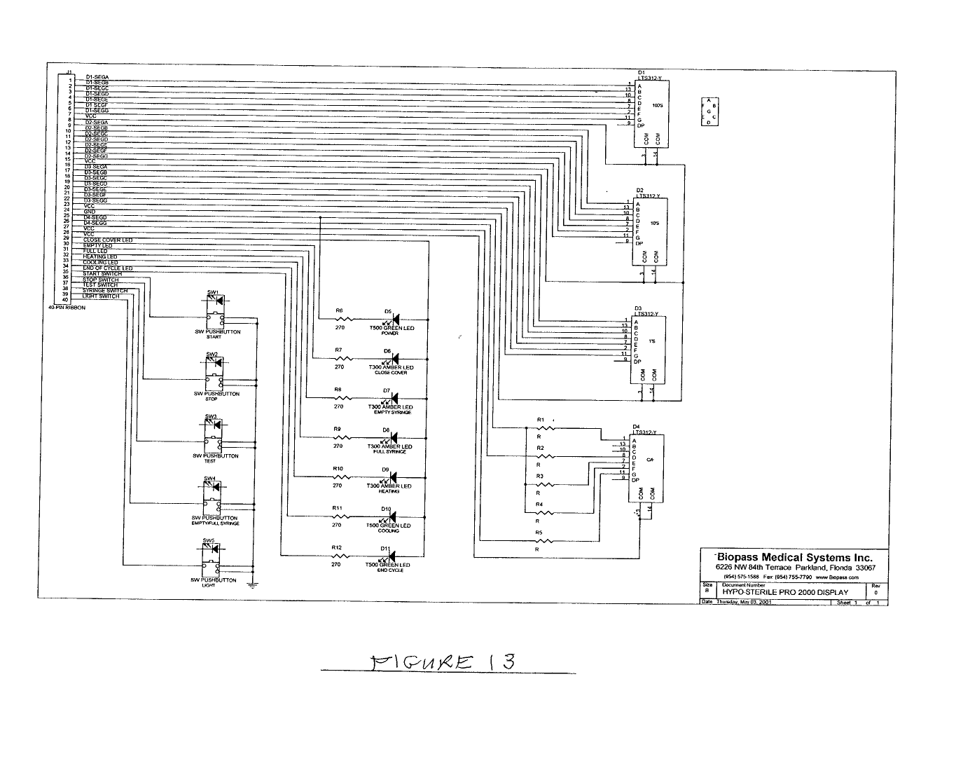

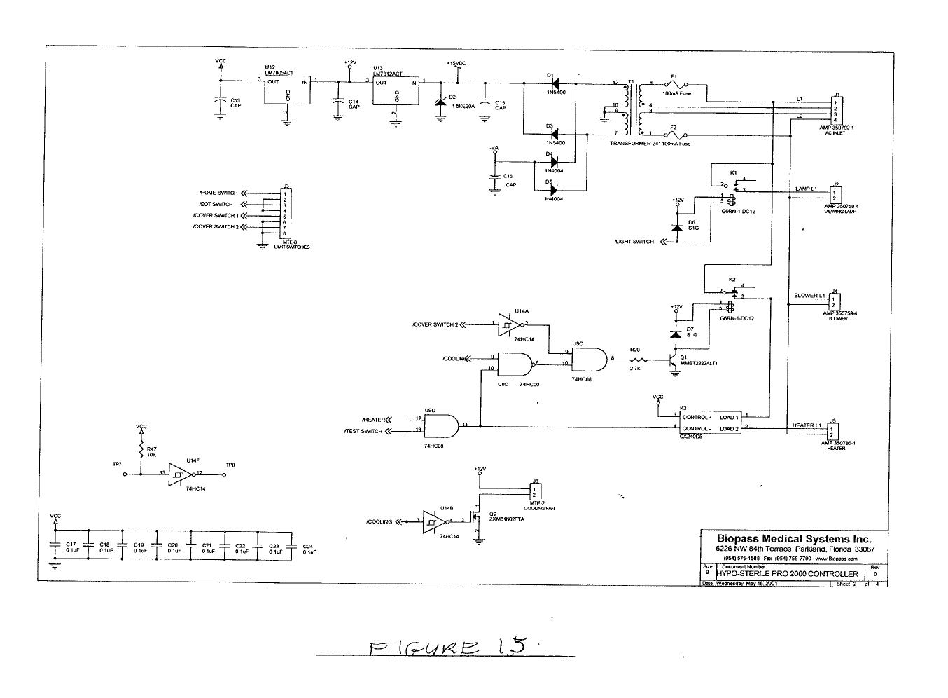

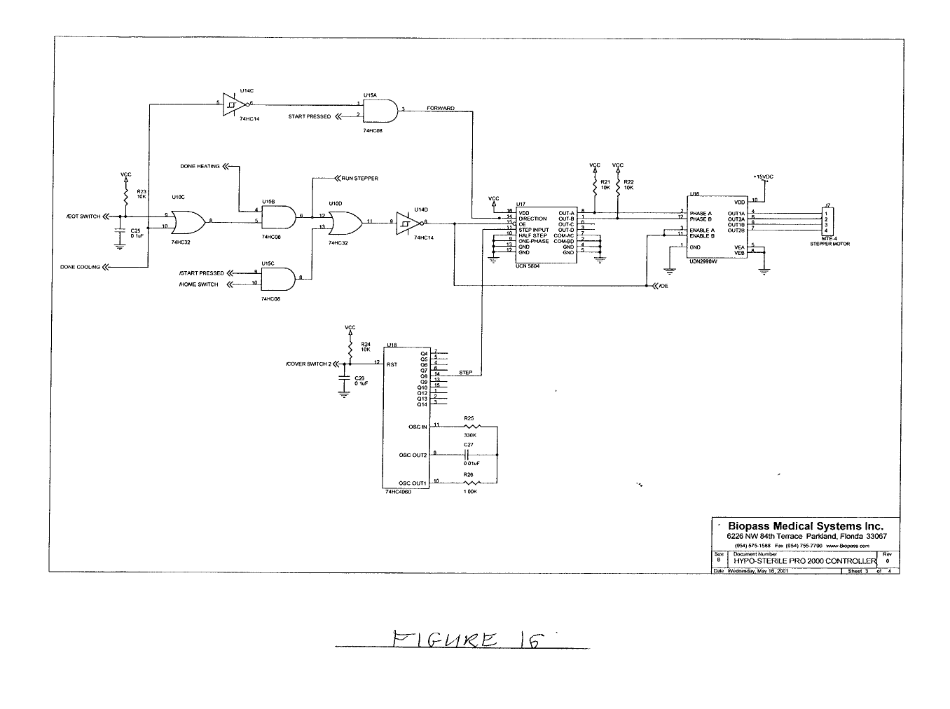

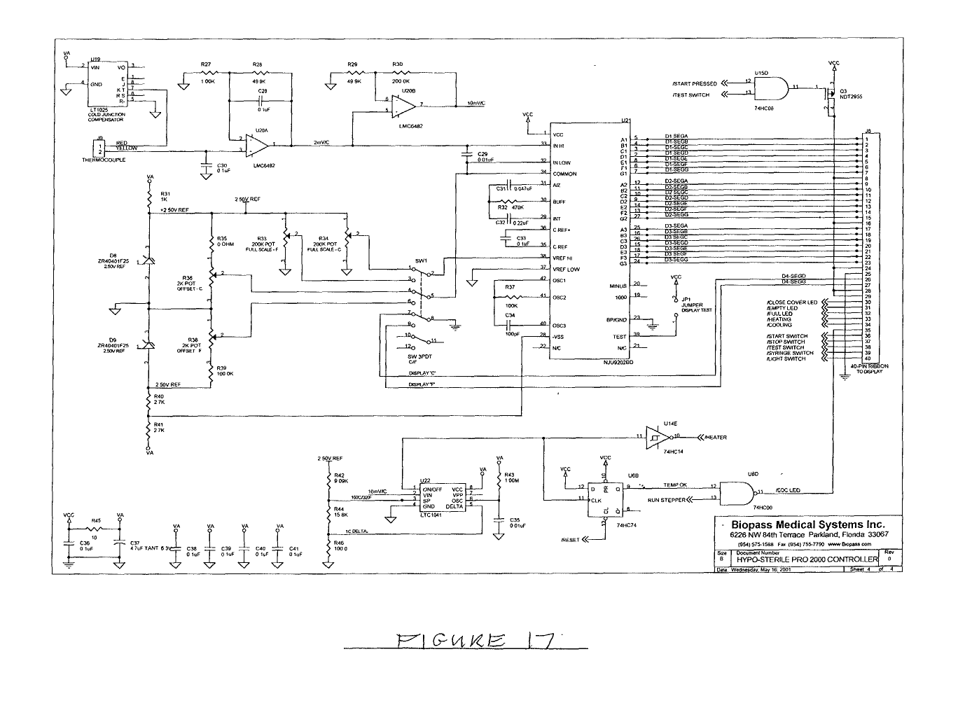

a Referring to FIGS. 1-17, an apparatus 10 is disclosed which disposes of infectious and sharps waste by decontaminating, melting and compressing plastic hypodermic syringes S and decontaminating, crushing and encasing needles N in melted syringe material. Apparatus 10 includes a waste compression cylinder 20 having a cylinder side wall 22 and a closed cylinder abutment end wall 24 and containing a waste compression piston 40 drivably connected to piston drive means 42, a cylinder waste receiving port 26 in cylinder side wall 22 and a corresponding cylinder waste receiving door 32, a waste releasing port 34 in cylinder side wall 22, and waste receiving door displacement means 28 which automatically??? opens and closes the waste receiving door 32 to pass waste W into the cylinder 20. See FIGS. 2 and 3. Piston drive means 42 slides the piston 40 away from cylinder abutment end wall 24 to open space for receiving waste W and slides the piston 40 toward and into close proximity with the cylinder abutment end wall 24 to crush needles N and compress melted syringe material around needles N. Two piston stop switches 44, in the form of limit switches, are provided in cylinder 20 which are electrically connected to piston drive means 42 to stop piston drive means 42 when the piston abuts and depresses either switch 44, thereby limiting the range of movement of the piston 40. See FIG. 2. An air heating means 60 is provided containing heating elements 62 for heating the decontaminating air to a decontaminating temperature. Decontaminating air blowing means 50 is further provided and oriented to blow decontaminating air through heating means 60 and through an air delivery elbow conduit 58 into cylinder 20 through an entry air port 52.

The air blowing means 60 contains circuitry including a timer permitting setting of a pre-set air blowing duration which is selected to be sufficient to cause decontamination of needles N and syringes S contained within the cylinder 20. The decontaminating air temperature is preferably elevated by the air heating means 60 to a sufficient level that it partially melts the syringe S material during the pre-set timer duration. The preferred air temperature is 1000 degrees Fahrenheit, although the temperatures may be selected depending upon the nature of the waste to be decontaminated, such as 450 degrees Fahrenheit. The air blowing means 50 preferably includes a squirrel cage blower 72 drivably connected to a blower motor 74 and delivering air into the air heating means 60 which is a tubular heating element preferably in the form of a cylinder, and from the heating element 60 into an elbow pipe 58 which is sealingly connected to the air entry port 52. The air passes through the cylinder 20 and out through the waste releasing port 34. The heating means 60 is preferably a FARNHAM™ electronics heating element, which preferably deactivates at a pre-selected heating time considered to be excessive and likely to harm apparatus 10 working elements.

Immediately subsequent to the timed delivery of decontaminated air into compression cylinder 20, the piston drive means 42 is activated and causes the piston 40 to advance toward and into close proximity with the cylinder abutment end wall 24, causing the needles N to bend and double over and causing the partially melted syringes S to become compressed and to flow around the bent, decontaminated needles N, thereby encasing the needles N in the syringe S material. Then the piston 40 is withdrawn by the piston drive means 42 to its initial position spaced apart from the abutment end wall 24 and the compressed and decontaminated waste W drops from the cylinder 20, preferably into a waste collection vessel 80 positioned below the cylinder waste releasing port 34.

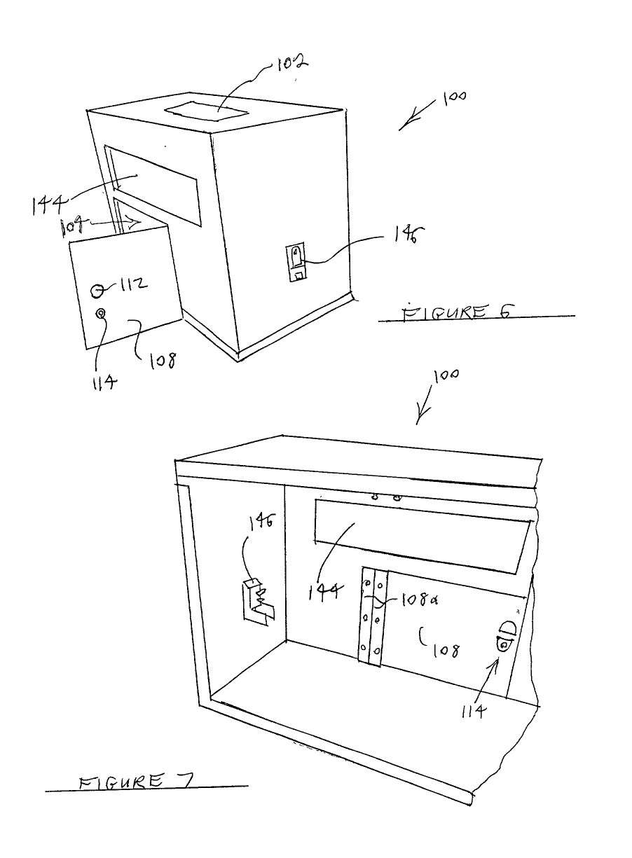

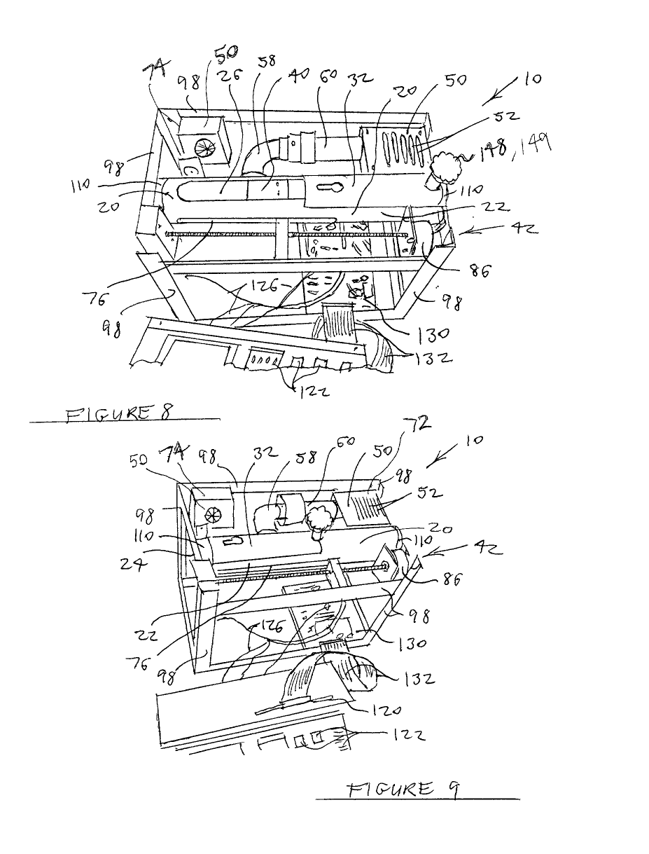

All of these elements preferably are contained within an apparatus housing 100 assembled around an apparatus housing frame 98 containing opposing cylinder mounting structures 110 which hold the cylinder 20 in a substantially horizontal position. See FIGS. 4 and 5. Housing 100 preferably includes a housing wall 116 a housing waste receiving opening 102 above covered by a housing waste receiving door 104 and registering with the cylinder waste receiving port 26. The housing waste receiving port is preferably closed by a housing waste receiving door which is preferably slidably mounted in opposing channel guides 106 and is manually slid by operating a lever mechanism 108 of conventional design. See FIG. 1. Housing waste receiving door limit switches 116 are preferably provided on housing 100 adjacent to waste receiving door 104 to stop door 104 from sliding beyond pre-set limits. Redundant limit switches 116 are also preferably provided for increased safety of operation. See FIG. 6. The waste collection vessel 80 is preferably removably fitted within the housing 100 below the cylinder waste releasing port 34, and a vessel removal port 118 is provided in the housing 100 for periodic removal, capping, disposing and replacing of the collection vessel 80 when the collection vessel 80 becomes full. A vessel removal door 108 pivotally mounted on hinges 108a preferably covers the vessel removal port 104 and is provided with a door opening knob 112 rotatably connected to a turn release door opening mechanism 114. The turn release door opening mechanism 114 preferably is a safety lock, preferably the type operated by the tubular keys 114a similar to those used to operate restricted elevators. See FIGS. 6 and 7. A waste receiving door gripping knob 148 is preferred.

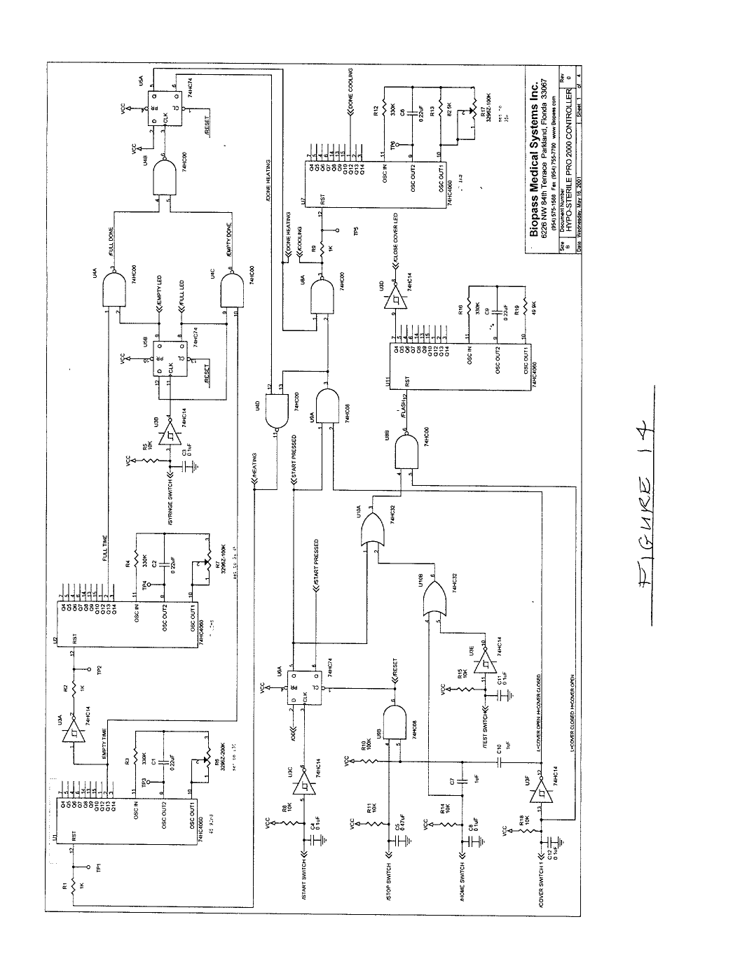

Collection vessel 80 is preferably a metal or heat resistant plastic can 80 having a lid 82 with internal lid threads 82a which screw onto external can threads 80a around the upper side wall of the can 80. See FIG. 12. Lid and can threads 82a and 80a preferably are of a mutually locking configuration so that once the lid 82 is screwed onto can 80, lid 82 does not screw off can 80 without use of tools and the partial destruction of can 80. The mutually locking configuration preferably includes one-way grooves in lid and can threads 82a and 80a, respectively.

The piston 40 is preferably a plunger disk having a threaded bore and the piston drive means 42 is preferably a drive screw 84 engagingly passing through the threaded bore and drivably connected to a piston drive Hearst motor 86. More preferably a lateral drive arm 88 extends out of cylinder 20 through a longitudinal slot 78, the external end of drive arm 88 including two threaded nuts through which an external drive rod 76 extends. Drive rod 76 preferably is rotated by a linear actuator 90, because of its operational speed is greater than a Hearst motor 86.

Apparatus 10 preferably includes at least one and preferably two separate apparatus upper and lower circuit boards 120 and 130, respectively, mounted within the apparatus housing 100. Lower circuit board 130 either constitutes or controls the apparatus 10 timers and transformer, and is connected to external apparatus controls 122 by circuit wires 124 and a wiring harness 132. Upper circuit board 120, which is an apparatus controls circuit board, essentially a microprocessor and controls and initiates the more complex functions of apparatus 10, is connected by wires to apparatus switches and to receiving door displacement means 28. Power is supplied to the apparatus circuitry through a power cord with a plug (not shown) removably connecting to an outlet 146 in the apparatus housing 100.

Although it is a less preferred variation, the receiving door displacement means 28 is a solenoid 92 drivably connected to receiving door 32 by linkages which are operated by solenoid switches 94 and controllingly connected to circuit timers and operational sequencing elements of conventional design contained within the apparatus circuit 126 which control the operation of the receiving door displacement means 28 and the piston drive means 42. Solenoid switches 94 are preferably limit switches, and an additional, redundant limit switch is preferably provided for enhanced safety.

Apparatus 10 includes a control panel 140 having flush, pressure activated control switches 142, the locations of which are marked by color shades and discrete pigmented areas of the control panel 140 outward surface. Control panel 140 fits into a control panel port 144 in housing 100 and displays decontaminating air temperature in either degrees Fahrenheit or degrees Celsius. The control panel 140 preferably includes controls such as a disposal starting switch.

In a prior and less preferred embodiment, the control panel 140 includes two spaced apart disposal starting switches 128 which are interconnected such that they must be depressed simultaneously to start the above-described sequence of operating events and functions. These two disposal starting switches 128 are preferably located on opposite ends of the apparatus housing 100, so that both hands of the operator are safely occupied as the apparatus 10 begins operation and thus cannot be injured by apparatus 10. Additional controls include stop/start, empty/full syringe, test mode and temperature. See FIG. 1.

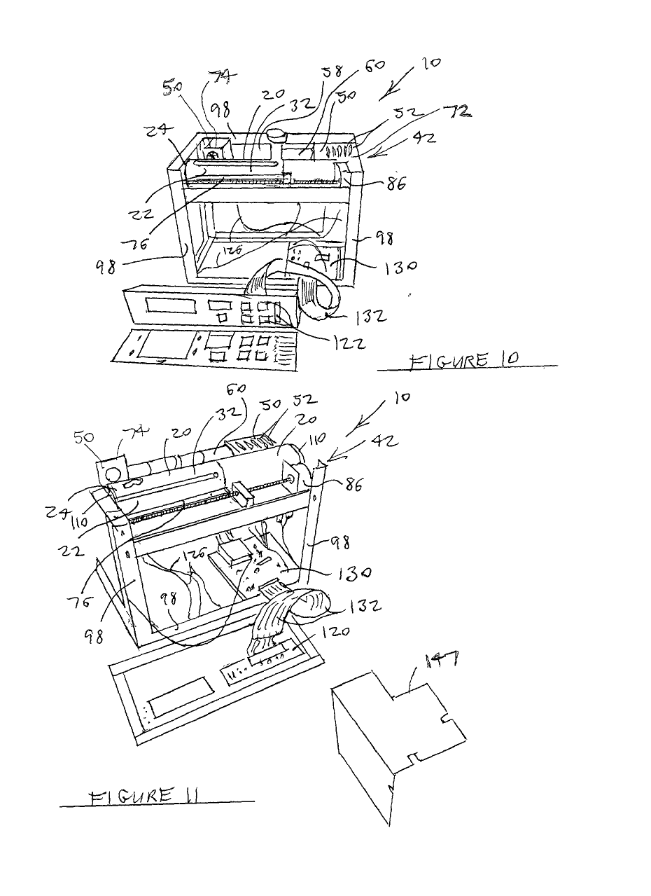

A cooling fan 150 is preferably provided within housing 100 to circulate air inside housing 100 and thus over electrical elements which can be damaged by excessive heat, such as the two circuit boards 120 and 130 and linear actuator 90. Cooling fan 150 is preferably fastened to an interior upper corner of frame 98. See FIGS. 8-10.

Housing frame 98 and cylinder 20 are both preferably made of 6061 aircraft aluminum. The housing 100 exterior surface is preferably painted bright red because this is an almost universally adopted hazard warning color. Housing 100 is preferably shaped as an elongate box, and is preferably formed of aluminum or stainless steel. A lower circuit board 130 heat shield 147 is preferably provided.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim as my invention:

1. An apparatus for decontaminating and destroying hypodermic syringes and needles, comprising
a waste compression cylinder having a cylinder side wall and a closed cylinder abutment end wall, and having a cylinder waste receiving port in said cylinder side wall and a waste releasing port in said cylinder side wall;
a waste compression piston slidably retained within said waste compression cylinder;
piston drive means drivably connected to said waste compression piston for driving said piston away from said abutment end wall to open space for receiving waste within said compression cylinder and for driving said piston toward and into close proximity with said cylinder abutment end wall to crush needles;
decontaminating air blowing means oriented to blow decontaminating air into said compression cylinder;
and air heating means for heating the decontaminating air to a decontaminating temperature.

2. The apparatus of claim 1, additionally comprising a waste receiving door movably covering said waste receiving port.

3. The apparatus of claim 3, additionally comprising a waste receiving door displacement means for automatically opening and closing said waste receiving door to pass waste into said cylinder.

4. The apparatus of claim 1, additionally comprising timer means for setting a duration for operation of said air blowing means sufficient to cause decontamination of needles and syringes contained within said compression cylinder.

5. The apparatus of claim 1, additionally comprising a waste collection vessel positioned below said cylinder waste releasing port.

6. The apparatus of claim 5, additionally comprising an apparatus housing having a housing wall and containing said compression cylinder and comprising compression cylinder mounting means holding said compression cylinder in a substantially horizontal position.

7. The apparatus of claim 6, additionally comprising a housing waste receiving opening in said housing wall located above and registering with said cylinder waste receiving port.

8. The apparatus of claim 7, additionally comprising a housing waste receiving door and housing waste receiving door displacement means.

9. The apparatus of claim 8, additionally comprising a waste collection vessel removably retained within said housing below said cylinder waste releasing port.

10. The apparatus of claim 9, additionally comprising a vessel removal port and vessel removal door removably covering said vessel removal port for providing access to said collection vessel for periodic removal and disposal of filled and capped collection vessel.

11. The apparatus of claim 10, wherein said vessel removal door comprises a door locking mechanism comprising means for locking said vessel door closed over said vessel port.

12. The apparatus of claim 9, wherein said waste collection vessel comprises:
a tubular vessel side wall having an upper side wall region with external vessel threads and having a vessel side wall lower end;
a vessel bottom wall sealingly secured across and closing the tubular vessel side wall lower end;
a vessel lid with internal lid threads sized and pitches to screw onto said external vessel threads.

13. The apparatus of claim 12, wherein said external vessel threads and said lid threads are of a mutually locking configuration such that once said vessel lid is screwed onto said vessel side wall upper end region, said vessel lid does not screw off said vessel side wall upper end region.

14. The apparatus of claim 13, wherein said external vessel threads and said lid threads comprise one-way grooves.

15. The apparatus of claim 1, additionally comprising an apparatus circuit comprising operation duration and sequencing means controlling operation of said piston drive means.

16. The apparatus of claim 15, additionally comprising an apparatus controls circuit board electrically connected to said apparatus circuit and having apparatus controls.

17. The apparatus of claim 1, wherein said piston drive means comprises:
a longitudinal slot in said cylinder;
a piston drive motor;
an external drive rod drivably connected to said piston drive motor;
and lateral drive arm having an external end and extending out of cylinder through said longitudinal slot, said external end of said drive arm holding two threaded drive nuts through which said external drive rod extends.
